(19) United States
(12) Patent Application Publication
(10) Pub. No.: US 2025/0251087 A1
(43) Pub. Date: Aug. 7, 2025

(54) METHOD FOR MANAGING A GAS COMING FROM A DRILLING WELL

(71) Applicant: Geolog Americas Inc., Houston, TX (US)

(72) Inventor: Antonio CALLERI, Milan (IT)

(73) Assignee: Geolog Americas Inc., Houston, TX (US)

(21) Appl. No.: 18/430,705

(22) Filed: Feb. 2, 2024

(51) Int. Cl. F17C 6/00; E21B 49/00; E21B 49/08

(52) U.S. Cl. CPC F17C 6/00; E21B 49/005; E21B 49/086; F17C 2201/0119; F17C 2201/058; F17C 2205/032; F17C 2227/0135; F17C 2250/0408

(57) ABSTRACT

A method for the management of a gas, the method comprising: providing a plurality of containers, each container comprising a body with an opening, a cap designed to cover the opening, the cap providing a suitable seat for a pierceable septum, and a pierceable septum; creating a vacuum inside the plurality of containers, said vacuum created through the pierceable septum, said pierceable septum configured to maintain a substantially airtight seal before and after a piercing operation; attaching at least one of said plurality of containers to a sampling device; filling said at least one container with a sampling gas provided by the sampling device by means of the pierceable septum.

### BACKGROUND OF THE INVENTION

### Field of the Invention

The methodology is related to the management of a gas coming from a gas well.

In the oil and gas industry, when drilling, a drilling fluid or “mud” is utilized to prevent the inclusion of formation fluids in the well shaft and evacuate the drilling debris and cuttings. During operation this fluid is cycled through the system from the surface down to the cutting head and back up again. Upon returning to the surface, the drilling mud contains content extracted at the bottom of the borehole. The mud is then filtered and reused in the drilling operation. The drilling mud, in addition to the cuttings and debris, contains gases which reveal vital information about the state of the well and surrounding rock strata. It is of particular interest to analyze the gas content of the returning drilling mud. Mud gas samples are then kept and used to perform analyses of the conditions at each stage in the drilling process.

The invention was developed to improve the ease and quality of the sampling process. In order to perform a subsequent analysis on those gases, an effective method for their management is necessary.

### SUMMARY OF INVENTION

The present invention provides a method for the management of a gas coming from a gas well.

Preferably, the method provides a plurality of containers.

Preferably, each of the plurality of containers comprises a body with an opening.

Preferably, each of the plurality of containers further comprises a cap designed to cover the opening which provides a suitable seat for a pierceable septum.

Preferably, each of the plurality of containers further comprises a pierceable septum.

Preferably, the method further comprises creating a vacuum inside the plurality of containers.

Preferably, the vacuum is created inside the plurality of containers through a pierceable septum.

Preferably, the pierceable septum is configured to maintain a substantially airtight seal before and after a piercing operation.

Preferably, the method further comprises attaching at least one of said plurality of containers to a sampling device.

Preferably, the method further comprises filling said at least one container with a sampling gas provided by the sampling device by means of the pierceable septum.

Preferably, the method further comprises completing an analysis upon the sampled gas.

Preferably, the analysis carried out upon the sampled gas are at least one of compositional and carbon isotope analysis (deltaC13).

Preferably, the analysis carried out upon the sampled gas comprises one or more of the following: Hydrocarbon Composition Analysis; Carbon, Hydrogen, Oxygen and Helium Isotopic Analysis; H₂, O₂, CO₂, N₂, He, Ar, Rn Concentration Analysis; other gaseous component analyses.

Preferably, the sampling gas belongs to a family of drilling mud gasses.

Preferably, the vacuum inside of said plurality of containers is created by a multi-vial evacuator.

Preferably, said multi-vial evacuator comprises a body.

Preferably, said multi-vial evacuator comprises a plurality of extraction sites.

Preferably, each extraction site is equipped with a first needle for piercing said pierceable septum.

Preferably, said multi-vial evacuator further comprises a vacuum pump.

Preferably, said vacuum pump is capable of creating a vacuum at each of said plurality of extraction sites.

Preferably, said filling step is performed by a gas distribution system.

Preferably, said gas distribution system comprises a body.

Preferably, said gas distribution system comprises a connection to a gas source.

Preferably, said gas distribution system comprises a sampling port capable of accepting a container.

Preferably, said gas distribution system comprises a second needle.

Preferably, said second needle is located inside the sampling port.

Preferably, the pierceable septum is comprised of butyl rubber.

Preferably, the pierceable septum is comprised of polytetrafluoroethylene.

Preferably, the butyl rubber and polytetrafluoroethylene are arranged in layers.

Preferably, the polytetrafluoroethylene layer is arranged to be in contact with the internal space defined by the container.

Preferably, the pierceable septum is suitably constructed so as to reversibly deform when pierced.

Preferably, the pierceable septum has a thickness suitable for manual use.

Preferably, the septum has a diameter suitable for the thickness of the same, said suitable diameter is related to a pressure difference between the interior and exterior pressure on the container.

Preferably, the septum has a diameter between 15 mm and 25 mm.

Preferably, the septum has a diameter substantially equal to 20 mm.

Preferably, the vacuum created inside the plurality of containers has a pressure equal to or less than 0.04 millibars.

Preferably, said first needle has a nominal diameter between 1 mm and 0.5 mm.

Preferably, said second needle has a nominal diameter between 1 mm and 0.5 mm.

Preferably, said gas distribution system further comprises a sensor to detect the completion of the filing step.

### BRIEF DESCRIPTION OF THE DRAWINGS

The scope of the invention will be defined more clearly in the detailed description where reference to the disclosed aspects will be made to the following exemplary figures.

FIG. 1 is a view of the individual container pieces.

FIG. 2 is a view of the assembled container, with the pierceable septum placed inside.

FIG. 3 is a flowchart of the process to be performed.

FIG. 4 is an exemplary multi-vial evacuator.

FIG. 5 is an exemplary sampling device.

### DETAILED DESCRIPTION

The method for the management of a gas, herein described, pertains to the efficient and interoperable management of gases. The gases of interest for this application belong to a family of mud gases which are collected and tested for the creation of well-site records.

The Applicant observes that drilling mud, also known as drilling fluid, is an engineered fluid which is circulated down the drill pipe and back to the surface during drilling activities. Its primary purposes are to cool and lubricate the drill bit, carry cuttings to the surface, and prevent the influx of formation fluids into the wellbore.

Mud gases are the gases derived from the formations exposed during drilling operations and entrained or dissolved in the drilling mud as it circulates through the wellbore. These gases can provide valuable information about the geological formations being drilled and conditions in the wellbore. The composition of mud gases may include various hydrocarbons, non-hydrocarbon gases (such as nitrogen and carbon dioxide, etc.), and other components which are indicative of the subsurface conditions.

Thus, mud gases are those gases which are extracted from a “drilling mud”. In the oil and gas industry, a drilling mud specifically refers to a fluid used during a drilling operation to mainly prevent the inclusion of formation fluids in the well shaft and evacuate the drilling debris and cuttings. Exemplary gases to be managed include Hydrocarbons, CO₂, Nitrogen.

The Applicant observes that laboratory analysis of mud gasses may include, but is not restricted to, the determination of Hydrocarbon composition alongside the analysis and determination of other gasses present, including but not restricted to H₂, O₂, CO₂, N₂, He, Ar and Rn Concentration. In addition, isotopic analysis of the gasses present, including but not restricted to Carbon, Hydrogen, Oxygen and Helium may also be performed.

Typically (but not only) for formation evaluation purposes, gas testing allows the evaluation of the composition and nature of gases released from the formations being drilled. Specific hydrocarbons present in the gas can serve as indicators of potential reservoirs, helping geologists assess the economic viability of the well. For the analysis of the mud gas, advanced techniques may be employed including, but not restricted to Gas Chromatography (GC), GC-Mass Spectrometry (GC-MS), GC Isotope Ratio Mass Spectroscopy (GC-IRMS) to provide detailed information about the nature and composition of gases, aiding in precise reservoir characterization and understanding of the origins and thermal maturity of hydrocarbons present.

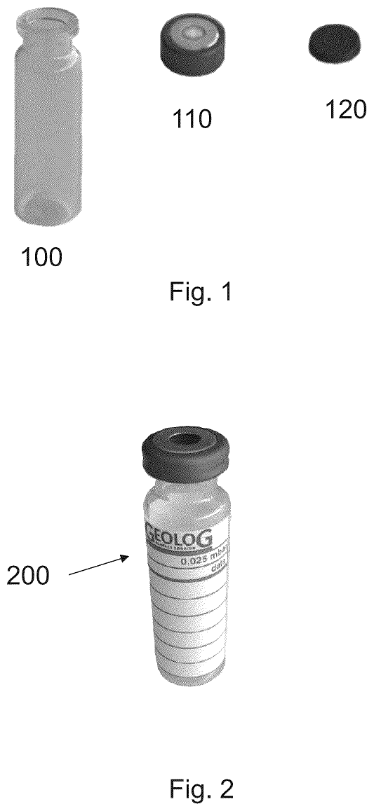

The assembled container 200, as shown in FIG. 2, is made up of the constituent parts shown in FIG. 1. The container comprises a body, 100. The body 100 defines an internal space which is necessary to collect a gas. The internal space can be of varying dimension and volume. In a specific embodiment, the interior space is equivalent to 20 mL. The container body can be realized in many materials which provide diverse physical and chemical resistance to different pressures and gases. Preferably, the container body 100 is realized in glass due to the chemical inertness of the material.

To enclose a gas in the container, the pierceable septum 120 is placed in the cap 110. The pierceable septum 120 has optionally multiple layers. In a particular embodiment, the pierceable septum is comprised of two layers. The innermost layer in contact with the interior space when attached is comprised of polytetrafluoroethylene. The innermost layer is chosen to be polytetrafluoroethylene due to its advantageous inertness but can optionally be comprised of a similar material. In a secondary layer located on the opposite face of the polytetrafluoroethylene, the pierceable septum comprises butyl rubber.

The pierceable septum 120 is designed in such a way that upon a piercing action, the septum seal is maintained. The pierceable septum layer construction is able to reversibly deform when a needle pierces the septum, allowing fluid to enter or exit the container. The deformation allows a needle to pierce the septum while, upon a removal of the needle, return to a closed state. The septum seal is capable of maintaining the seal for an extended period of time. The extended period of time preferably corresponds to a minimum time period of one year.

The pierceable septum 120 may be pierced a number of times without degradation of its sealing capability, allowing for initial evacuation and subsequent filling with the gas sample to be analysed, followed by multiple piercings to extract the gas sample for laboratory analysis.

The pierceable septum 120 has a thickness which is suitable for manual use. When utilized by a technician, the pierceable septum and needle may be subject to lateral forces due to imperfect needle insertion. A larger thickness can impart enough lateral force to break a needle or interrupt a sampling action while a thinner septum may reduce the duration and quality of the seal. The septum thickness is preferably in the range of 2 to 4 mm. In practice, this thickness corresponds to substantially 3 mm.

The pierceable septum diameter may depend upon, among other things, the thickness of the same and pressure inside the container. Due to differences in pressure and area over which the septum stretches, the acceptable diameter of the pierceable septum may vary. With a greater differential pressure, the force acting upon the pierceable septum is greater. With a greater force applied to the pierceable septum, the ability to reseal and maintain the seal diminishes. The allowable diameter is therefore smaller, all else being equal. Preferably, the pierceable septum diameter is substantially equal to 20 mm.

The cap 110 shown in FIG. 1 is designed to accommodate the pierceable septum 120. The cap 110 is designed to fit against the container body through a crimping action or equivalent fastening mechanism. The fastening action can optionally be performed through a threaded connection between the container body and cap. Upon a fastening action, the pierceable septum 120, arranged such that the polytetrafluoroethylene layer is in contact with the interior space, is tightened against the body 100 to create a substantially airtight seal. This airtight seal can maintain the composition and pressure inside of the container for an extended period of time. The extended period of time may correspond to a minimum of one year. In some embodiments of the invention, the time period may be longer or shorter depending upon the application.

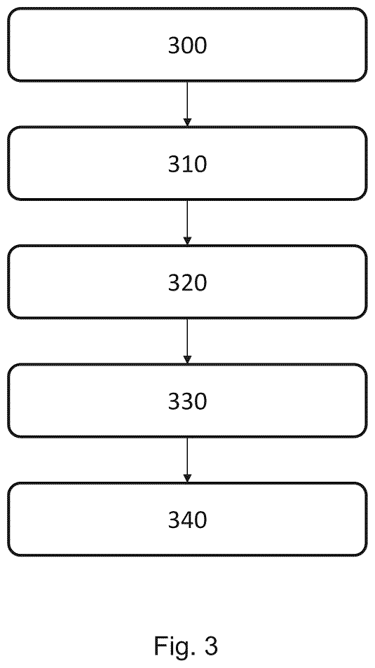

The method for the management of a gas shown in FIG. 3 begins with a first step of providing a plurality of assembled containers 300. The containers supply a starting point into which the successive steps may be performed. In a second step, 310, a vacuum is created inside of a container. The vacuum pressure created inside of the container may vary depending upon the structure and material of the container and pierceable septum.

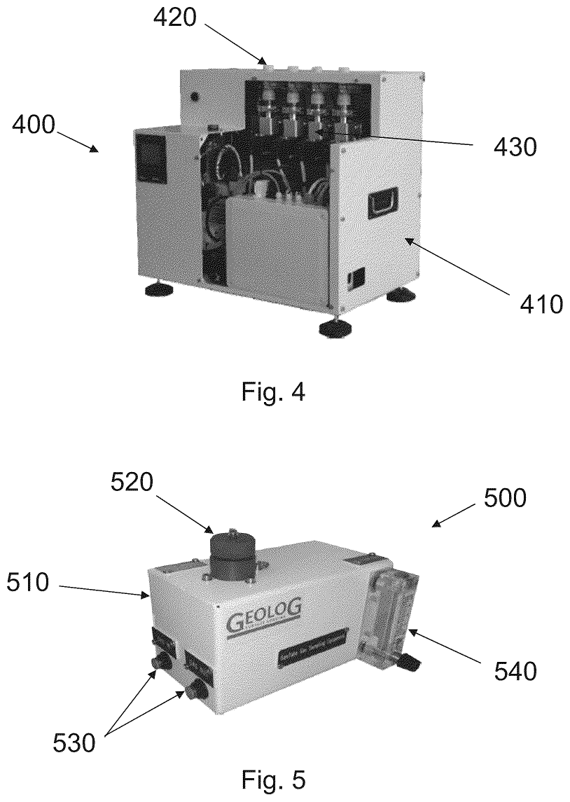

The vacuum pressure in the assembled containers is created in step 310 by a multi-vial evacuator shown in FIG. 4. The multi-vial evacuator 400, comprises a body 410, used to house the other aspects of the evacuator. The multi-vial evacuator 400 additionally includes a plurality of extraction sites 420, and a vacuum pump 430. The vacuum pump 430 may comprise a single vacuum pump or additional vacuum pumps. A single vacuum pump may connect to each of the plurality of extraction sites 420, or a respective vacuum pump may be connected to each respective extraction site 420. Each extraction site 420 additionally includes a respective first needle. The first needle is connected to the vacuum pump 430 allowing for the vacuum pump to evacuate the container 200 of ambient air. The insertion of each container 200 into each respective extraction site 420 begins by piercing the pierceable septum 120 with a respective first needle located inside the extraction site 420. Once started by the operator, the vacuum pump 430 evacuates the container to the specified vacuum pressure. The resulting vacuum pressure inside the container can vary. Preferably, the vacuum pressure is less than or equal to 0.04 millibar. Ideally, the vacuum pressure in the container is equal to 0.025 millibar. Each container, after the evacuation, is removed from the first needle and used for the next steps of the gas management methodology herein disclosed.

The attaching step 320 connects the evacuated containers 200 to a sampling device 500.

The sampling device 500 may comprise a gas distribution system which comprises a body 510 with a connection to a gas source 530, a sampling port 520 which can accommodate the evacuated containers, and a second needle located inside the sampling port through which the gas can flow. The connection of the evacuated containers to the sampling device 500 occurs by means of the second needle and pierceable septum 120. When the evacuated container is inserted into the sampling port 520, the connection is established by the second needle piercing the pierceable septum, connecting the internal vacuum to the gas source.

A filling step 330 is then performed, where the vacuum pressure inside the evacuated container draws the sampling gas into the container.

A needle used to pierce the pierceable septum may vary in size depending on the process requirements. For a quicker processing time, the needle may be of a larger gauge. For a slower process, the needle may be of a smaller gauge. In one embodiment, the first and second needle nominal outer diameter may range from 0.5 mm to 1 mm. In a particular embodiment, the first or second needle may correspond to a gauge of G23.

Additionally, the sampling device 500 may contain a sensor 540 to signal a filling operation being performed. Preferably, this sensor 540 is a flowmeter. When filling, the flowmeter connected to the gas source signals the filling operation by transitioning from a 0 value to a non-zero value after which, as the pressures equalize between the now-filled evacuated container, the flow value returns to 0 when the filling is finished.

The gas contained in the previously filled container may then be analyzed in an optional step 340 to determine the properties of the gas. The analysis may comprise several tests, including, but not restricted to, Hydrocarbon Composition Analysis, Carbon, Hydrogen, Oxygen and Helium Isotopic Analysis, H₂, O₂, CO₂, N₂, He, Ar, Rn Concentration Analysis and other gaseous component analyses via a number of analytical techniques, including but not restricted to Gas Chromatography (GC), GC-Mass Spectrometry (GC-MS), GC Isotope Ratio Mass Spectroscopy (GC-IRMS).

In order to perform such analysis, the pierceable septum 120 is pierced by a further needle, connected to the analysis equipment. In this way, part or all the gas contained in the container 200 flows from the inside of the same container 200 to the analysis equipment. In case different analysis are to be carried out, the pierceable septum 120 can be pierced multiple times, possibly with different needles, so as to let quantities of gas reach different analysis devices.

1. A method for the management of a gas, the method comprising:
Providing a plurality of containers, each container comprising a body with an opening, a cap designed to cover the opening, the cap providing a suitable seat for a pierceable septum, and a pierceable septum;
Creating a vacuum inside the plurality of containers, said vacuum created through the pierceable septum, said pierceable septum configured to maintain a substantially airtight seal before and after a piercing operation;
Attaching at least one of said plurality of containers to a sampling device;
Filling said at least one container with a sampling gas provided by the sampling device by means of the pierceable septum.

2. The method according to claim 1, further comprising completing an analysis upon the sampling gas, said analysis being at least one of compositional and carbon isotope analysis (deltaC13).

3. The method according to claim 1, wherein the sampling gas belongs to a family of drilling mud gasses.

4. The method according to claim 1, wherein said vacuum inside of said plurality of containers is created by a multi-vial evacuator, said multi-vial evacuator comprising:
A body;
A plurality of extraction sites, each extraction site equipped with a respective first needle for piercing said pierceable septum;
A vacuum pump, capable of creating a vacuum at each of said plurality of extraction sites by means of said respective first needle.

5. The method according to claim 1, wherein said sampling device is a gas distribution system, said gas distribution system comprising:
A body,
A connection to a gas source,
A sampling port capable of accepting a container,
A second needle, said second needle located inside the sampling port.

6. The method according to claim 1, wherein the pierceable septum is comprised of butyl rubber and polytetrafluoroethylene.

7. The method according to claim 6, wherein the butyl rubber and polytetrafluoroethylene are arranged in layers, and wherein the polytetrafluoroethylene layer is arranged to be in contact with the internal space defined by the container.

8. The method according to claim 1, wherein the pierceable septum is suitably constructed so as to reversibly deform when pierced.

9. The method according to claim 1, wherein the pierceable septum has a thickness suitable for manual use.

10. The method according to claim 9, wherein the pierceable septum has a thickness between 2 mm and 4 mm.

11. The method according to claim 10, wherein said thickness is substantially equal to 3 mm.

12. The method according to claim 1, wherein the septum has a diameter suitable for the thickness of the same, said suitable diameter is related to a pressure difference between the interior and exterior pressure on the container.

13. The method according to claim 12, wherein the septum has a diameter between 15 mm and 25 mm.

14. The method according to claim 13, wherein the septum has a diameter substantially equal to 20 mm.

15. The method according to claim 1, wherein the vacuum created inside the plurality of containers has a pressure equal to 0.04 millibar or less.

16. The method according to claim 4, wherein said first needle has a nominal outer diameter between 1 mm and 0.5 mm.

17. The method according to claim 5, wherein said second needle has a nominal outer diameter between 1 mm and 0.5 mm.

18. The method according to claim 5, wherein said gas distribution system further comprises a sensor to detect the completion of the filing step.
